(19) United States
(12) Patent Application Publication
(10) Pub. No.: US 2013/0197988 A1
(43) Pub. Date: Aug. 1, 2013

(54) MANAGEMENT APPARATUS AND MANAGEMENT METHOD

(71) Applicants: Takayuki Natsume, Minato-ku (JP); Kengo Shinoda, Minato-ku (JP); Takuya Hashimoto, Minato-ku (JP)

(72) Inventors: Takayuki Natsume, Minato-ku (JP); Kengo Shinoda, Minato-ku (JP); Takuya Hashimoto, Minato-ku (JP)

(73) Assignee: KONAMI DIGITAL ENTERTAINMENT CO., LTD., Minato-ku, Tokyo (JP)

(21) Appl. No.: 13/878,633

(22) PCT Filed: Jun. 20, 2012
(86) PCT No.: PCT/JP2012/065683

§ 371 Date: Apr. 10, 2013

(30) Foreign Application Priority Data
Jun. 20, 2011 (JP) 2011-135928
Jun. 12, 2012 (JP) 2012-133144

(51) Int. Cl. G06Q 30/02

(52) U.S. Cl. CPC G06Q 30/0233
USPC 705/14.33

(57) ABSTRACT

When a management apparatus receives a purchase request REQ, the management apparatus obtains a rank corresponding to a member ID, and obtains member IDs of friends corresponding to the member ID. A CPU accesses a member database to obtain a rank corresponding to the member ID of each friend to specify the highest rank out of the obtained ranks. The CPU obtains a discount ratio corresponding to the highest rank. The CPU calculates an amount of payment by applying the discount ratio to an amount of money for goods or services as a purchased subject, and sends a purchase response including the amount of the payment to a communication device.

### TECHNICAL FIELD

The present invention relates to techniques of member systems and the like provided for general membership services sites and Social Networking Service (SNS) sites.

### BACKGROUND ART

In recent years, the recruitment of new members has been performed on websites, so that the purchase of goods or services has been offered to registered members. A reservation support system for a golf course is known as such a member system (see Patent Document 1).

There is a well-known member system in which points corresponding to a purchase price are provided when the purchase is made on a website, so that a discount will be offered at the next purchase by using the points.

### CITATION LIST

### Patent Document

Patent Document 1: JP 2011-53814 A

### SUMMARY OF INVENTION

### Technical Problem

Since points have liquidity in a conventional member system, the purchase of goods or services gives an incentive to use the member system at the next purchase.

Such an incentive is held by individual members, but does not stimulate activity in the entire member system.

In view of the above situation, the present invention aims to provide a member system in which activity of a member on a website can stimulate activity of the other members.

### Solution to Problem

A measure employed in the present invention to solve the problem will be described below. A management apparatus according to the present invention, for managing a website for multiple members, which includes: a point generating unit adapted for generating points in accordance with the degree of activity of the members on the website, a rank deciding unit adapted for evaluating the activity of each of the multiple members to decide a rank, a database, in which identification information that identifies the members, the points of the members, ranks of the members, and identification information of a member who has a friend relationship with the members are associated with each other and stored, a privilege table, in which privilege in accordance with the rank is stored, a rank specifying unit adapted for, when a purchase request indicating the purchase of goods or services provided on the website is received, obtaining the identification information of a friend corresponding to the identification included in the purchase request from the database, obtaining ranks corresponding to the identification information of the member who sent the purchase request and the identification information of the friend from the database, and specifying the highest rank out of the obtained ranks, and a privilege obtaining unit adapted for referring to the privilege table to obtain privilege corresponding to the rank specified by the specifying unit, in which the obtained privilege is applied to the purchase of goods or services of the member.

It should be noted that the “activity” includes not only purchase of goods or services but also contribution to the other members, such as a performance of an answer to a question posted on the website, hosting of a reservation of a golf course, which multiple members make jointly. It should be noted that the “privilege” includes various special treatments, such as a discount ratio applied to purchase of goods or services, treatment in which a member can purchase goods or services prior to the other members, progression in quality of goods, and increase of amount of goods.

In the above-described management apparatus, it is preferable that the point generating unit generate the points relating to an amount of payment of the member in the purchase and generate the points in accordance with the activity, which the member carries out with respect to the other members. It should be noted that the “relating to an amount of payment” includes points in proportion to an amount of payment, and a range such as 100 points per ten thousand yen in an amount of payment. In short, the points may be decided in accordance with a predetermined rule.

In the above-described management apparatus, it is preferable that the management apparatus include a total table, in which the identification information and the total value of the points generated by the point generating unit are associated with each other and stored, and the rank deciding unit evaluates the activity of each of the multiple members to decide the rank on the basis of the total value of the points stored in the total table.

The rank deciding unit may include a reference table, in which multiple reference points as references of ranking are stored, and evaluate the activity of each of the multiple members to decide the rank on the basis of the reference table and the total value of the points stored in the total table for a predetermined period.

In the above-described management apparatus, it is preferable that individual points obtained by the members and time when the points are obtained are associated with each other and stored in the database, and the rank deciding unit includes a reference table, in which multiple reference points as references of ranking are stored, and the rank deciding unit accumulates the points obtained for a predetermined period by referring to the database, decides the rank for each of the multiple members by comparing the accumulated points with the reference points, and stores the decided rank in the database.

In the above-described management apparatus, it is preferable that the management apparatus include a changing unit adapted for changing the multiple reference points stored in the reference table so that the ratio of the members belonging to each rank goes to a predetermined ratio.

The management apparatus of the present invention, being for managing a website for multiple members, and being capable of communicating with a database in which identification information identifying the members, points of the members, ranks of the members, and identification information of members who have a friend relationship with the members are associated with each other and stored, which includes: a point generating unit adapted for generating points in accordance with the degree of activity of the members on the website, a rank deciding unit adapted for evaluating the activity of each of the multiple members to decide the rank, a reflecting unit adapted for reflecting the decided rank in the database, a privilege table, in which privilege in accordance with the rank is stored, a rank specifying unit adapted for, when a purchase request indicating the purchase of goods or services provided on the website is received, obtaining the identification information of a friend corresponding to the identification included in the purchase request from the database, obtaining ranks corresponding to the identification information of the member who sent the purchase request and the identification information of the friend from the database, and specifying the highest rank out of the obtained ranks, and a privilege obtaining unit adapted for referring to the privilege table to obtain privilege corresponding to the rank specified by the specifying unit, in which the obtained privilege is applied to the purchase of goods or services of the member.

A management method according to the present invention, is a method for being performed in a management apparatus for managing a website for multiple members, which includes: generating points in accordance with the degree of activity of the members on the website, evaluating the activity of each of the multiple members to decide a rank, associating identification information that identifies the members, the points of the members, ranks of the members, and identification information of a member who has a friend relationship with the members with each other and storing them, storing privilege in accordance with the rank, when a purchase request indicating the purchase of goods or services provided on the website is received, obtaining the identification information of a friend corresponding to the identification included in the purchase request from the database, obtaining ranks corresponding to the identification information of the member who sent the purchase request and the identification information of the friend from the database, specifying the highest rank out of the obtained ranks, and obtaining privilege corresponding to the rank specified by the specifying unit, in which the obtained privilege is applied to the purchase of goods or services of the member.

A management method for being performed in a management apparatus for managing a website for multiple members, and being capable of communicating with a database in which identification information identifying the members, points of the members, ranks of the members, and identification information of members who have a friend relationship with the members are associated with each other and stored, which includes: generating points in accordance with the degree of activity of the members on the website, evaluating the activity of each of the multiple members to decide the rank, reflecting the decided rank in the database, storing privilege in accordance with the rank, when a purchase request indicating the purchase of goods or services provided on the website is received, obtaining the identification information of a friend corresponding to the identification included in the purchase request from the database, obtaining ranks corresponding to the identification information of the member who sent the purchase request and the identification information of the friend from the database, specifying the highest rank out of the obtained ranks, and obtaining privilege corresponding to the rank specified by the specifying unit, in which the obtained privilege is adopted for the purchase of goods or services of the member.

### BRIEF DESCRIPTION OF DRAWINGS

FIG. 1 is a block diagram of a member system according to a first embodiment of the present invention,

FIG. 2 is a block diagram showing a function of a management apparatus,

FIG. 3 is a block diagram showing a configuration of the management apparatus,

FIG. 4 is an explanatory view showing an example of a data structure of a member database,

FIG. 5 is an explanatory view showing an example of stored contents of a privilege table,

FIG. 6 is an explanatory view showing an example of stored contents of a reference table,

FIG. 7 is a sequence diagram showing the operation of the member system relating to the registration of point information,

FIG. 8 is a sequence diagram showing the operation of the member system relating to the registration of friend relationship,

FIG. 9 is a sequence diagram showing the operation of the member system relating to the purchase of goods or services,

FIG. 10 is a flow chart showing the operation of a CPU relating to an updating process of a rank,

FIG. 11 is a block diagram showing a function of a management apparatus of a variation,

FIG. 12 is an explanatory view showing an example of stored contents of a total table of the variation,

FIG. 13 is a flow chart showing the operation of a CPU relating to an updating process of a rank of the variation,

FIG. 14 is a block diagram showing a function of the management apparatus of the variation,

FIG. 15 is a flow chart showing the operation of the CPU relating to a changing process of reference points of the variation,

FIG. 16 is a block diagram of a member system of the variation,

FIG. 17 is a block diagram showing a function of the management apparatus of the variation,

FIG. 18 is a block diagram showing a function of the management apparatus of the variation, and

FIG. 19 is a block diagram showing a function of the management apparatus of the variation.

### EMBODIMENTS OF INVENTION

### 1. Configuration of Member System

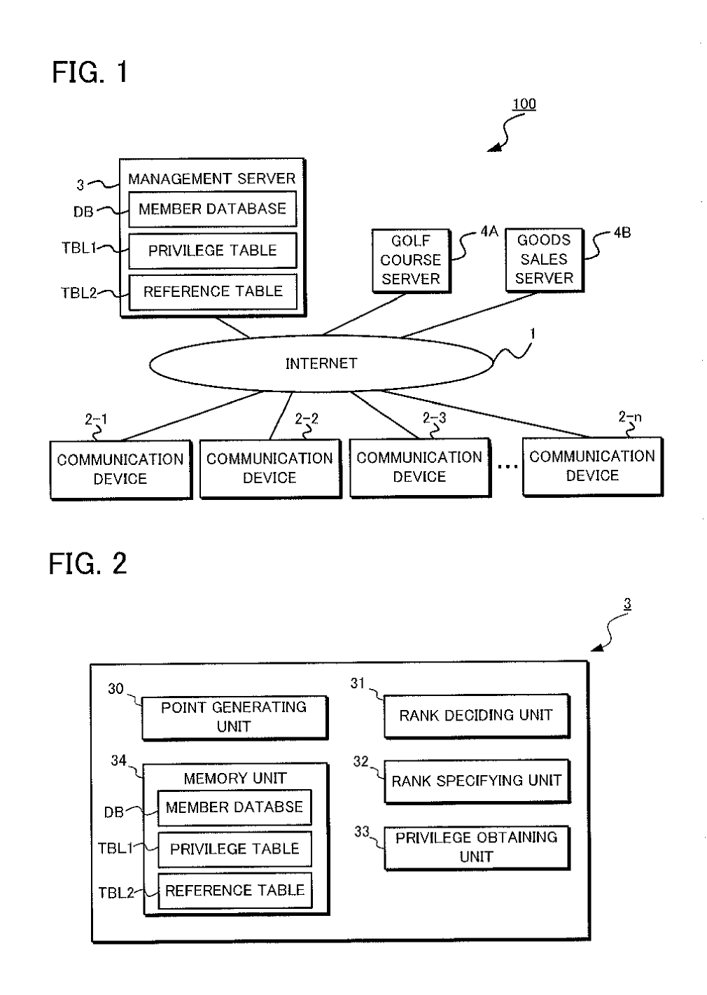

FIG. 1 is a block diagram of a member system 100 according to an embodiment of the present invention. The member system 100 provides a place for purchasing services such as a reservation of a golf course and goods such as a golf club to members of a website. The member system 100 provides a place for communication between the members. For example, it is possible to post a question relating to golfing and an answer to the question, and to invite the other members to a golf competition, which one of the member plans.

To expedite activity of the members on the website, such as purchase of goods and services, posting of questions and answers, the member system 100 generates points corresponding to the degree of activity of the members to provide the points to the members.

The member system 100 is provided with communication devices 2-1, 2-2, 2-3 . . . 2-n of the members, a management apparatus 3 managing an SNS and the purchase of goods and services, a golf course server 4A, a goods sales server 4B, and an Internet 1 functioning as a communication network. The communication devices 2-1 . . . 2-n of the members can communicate through the Internet 1, and are provided with a browser function and an e-mail function. The communication devices correspond to a personal computer and a mobile phone, for example. The golf course server 4A is a server operated by an administrator of a golf course, which provides information on an offer of a reservation for a subject of use to the management apparatus 3. The goods sales server 4B is a server operated by an administrator in a goods sales company, which provides information on a sale of goods to the management apparatus 3.

The function of the management apparatus 3 will be described in reference to FIG. 2. As shown in this figure, the management apparatus 3 is provided with a point generating unit 30, a rank deciding unit 31, a rank specifying unit 32, a privilege obtaining unit 33, and a memory unit 34.

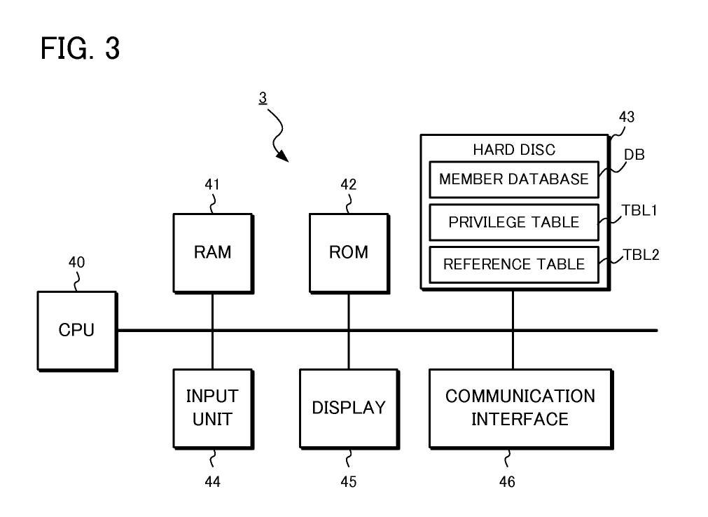

The point generating unit 30 generates points corresponding to the degree of activity of members on the website. The rank deciding unit 31 evaluates activity of each of multiple members on the basis of the generated points to decide a rank. The rank specifying unit 32 receives purchase request indicating the purchase of goods or services, which is provided on the website, from communication devices 2-1 . . . 2-n of the members, so that the rank specifying unit 32 obtains identification information of friends corresponding to the identification information included in the purchase request from a database. Furthermore, the rank specifying unit 32 obtains a rank corresponding to identification information of the member, who purchases the goods or services, and ranks corresponding to the identification information of the friends from the database to specify the highest rank out of the obtained rank. The privilege obtaining unit 33 refers to the privilege table to obtain privilege corresponding to the rank specified by the rank specifying unit 32. The point generating unit 30, the rank deciding unit 31, the rank specifying unit 32, and the privilege obtaining unit 33 are functional blocks achieved by functioning according to a computer program executed by a central processing unit (CPU) shown in FIG. 3. The memory unit 34 stores various programs and data. In the memory unit 34, a member database DB, a privilege table TBL1, and a reference table TBL2 are stored. The memory unit 34 is a functional block achieved by a hard disk or the like, for example.

FIG. 3 shows the structure of the management apparatus 3. As shown in this figure, the management apparatus 3 is provided with a central processing unit (CPU) 40, which controls the entire device, a random access memory (RAM) 41, which serves as the work area of the CPU 40, a read only memory (ROM) 42, which stores a boot program and the like, a hard disk 43, which stores various programs and data, an input unit 44, which includes a keyboard, a mouse, and the like, a display 45, which displays images, and a communication interface 46, which communicates with an external device through the Internet 1. In the hard disk 43, the member database DB, the privilege table TBL1, and the reference table TBL2 are stored. The management apparatus 3 may be provided with multiple servers, so that a server managing the reservation of a subject of use may be provided independently of a server providing the member database DB.

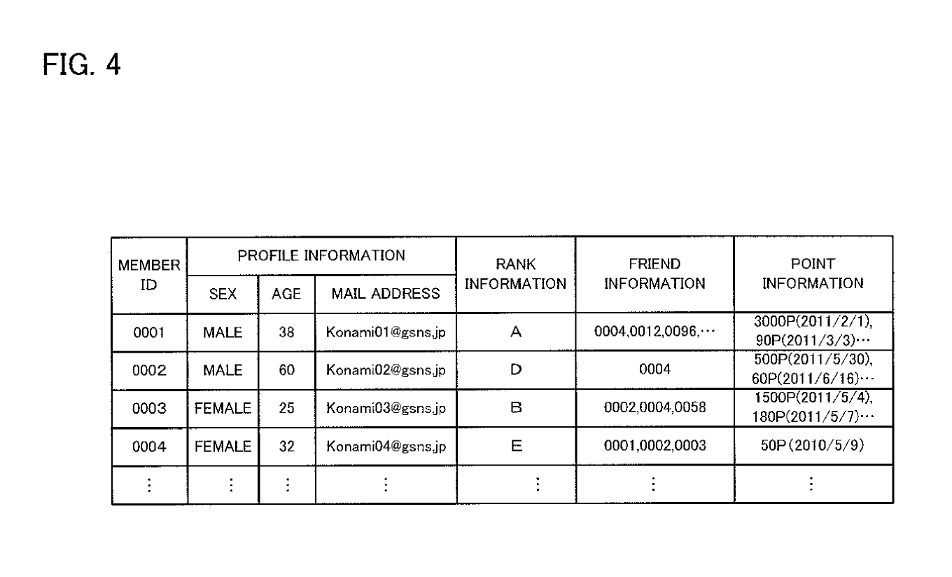

FIG. 4 shows a part of a data structure of data stored in the member database DB. As shown in this figure, in the member database DB, member identification information (ID), which uniquely identifies each member, profile information, rank information, friend information, and point information are associated with each other and is stored.

The profile information includes sex, age, address, and e-mail address. In addition, the profile information may include a golf play history, membership or no membership, owned clubs, skill, and an evaluation value. The membership is one for a golf course. The skill means a golf handicap. The evaluation value is a cumulative value evaluated for manners and likability of an evaluated member after play by a member who has played golf together with the evaluated member. For example, the evaluation is conducted by grading the manners and likability on the point scale: “2” for “very good,” “1” for “good,” “0” for “normal,” “−1” for “poor,” and “−2” for “very poor.”

The point information is one indicating points, which are given in accordance with the activity of members on the website, and the time when the points are given. In the embodiment, the points are given in accordance with the activity of members on the website, such as the purchase of goods or services, and contribution to other members. For example, points corresponding to one-tenth of the amount of the payment for the purchase of goods or services are given. When an answer is given to a question posted on the website, 50 points are given. When the reservation of a golf competition, which multiple members make jointly, is hosted, 100 points are given.

The rank information is one indicating rank, in which the degree of the activity of members on the website is divided into multiple stages on the basis of the point information. In the embodiment, members are divided into the five-grade, from rank A to rank E. Since the points are given in accordance with the activity on the website, in proportion as a member has a high rank (the closer to “A” rank is, the higher the rank is), it can be said that the member contributes to the activity of the website. As described below, in view of increasing the activity of members on the website, the management apparatus 3 gives the members the motivation to aim at a higher rank by giving the members privileges in accordance with the rank.

The friend information is provided with the member IDs of members having the relationship of friends. In the example shown in FIG. 4, the member with the member ID “0002” has the relationship of friends to the member with the member ID “0004”. On the website, the other members can browse a member page disclosing rank, sex, age, and the like. When a member accepts the offer of a friend request from another member who is interested in the member, the relationship of friends is built and is stored in the member database DB.

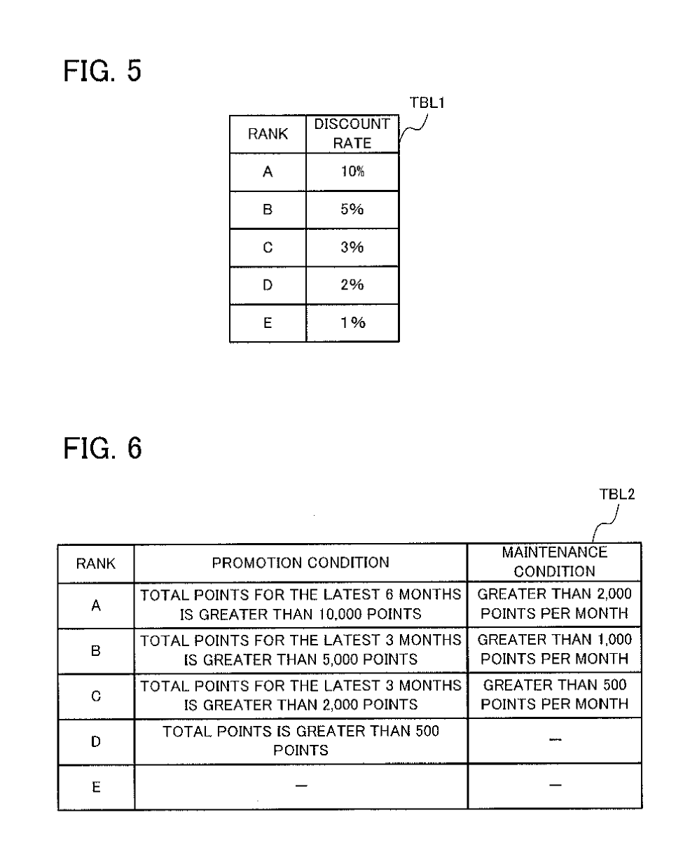

One example of the stored contents of the privilege table TBL 1 is shown in FIG. 5. In this example, a discount rate is adopted as the privilege that is given in accordance with the rank. The discount rate indicates a rate that is discounted from the fixed price when a member purchases services or goods. In this example, the discount rate for the rank A is 10%. The discount rate for the rank E is 1%. The higher the rank is, the greater the discount rate is.

In the member system 100, the discount rate corresponding the highest rank among one member's rank and friend members' ranks is applied to the purchase of goods or services. Therefore, since the members try to build the relationship of friends positively, and it is possible to stimulate the activity of the members on the website.

The privilege is not limited to the discount rate. If it is possible to give an advantage to the activity on the website, anything may be adopted as the privilege. For example, for the purchase of services or goods, a gift, which is given in accordance with the rank, may be prepared. In proportion as the rank is higher, a higher priority for the purchase may be given.

In the reference table TBL2, conditions for classifying the ranks are stored. In the embodiment, the rank is given on the basis of the points that a member obtains. In this example, the conditions for classifying the ranks are provided with a promotion condition for promoting from a lower rank to a higher rank and a maintenance condition for maintaining a current rank.

FIG. 6 shows the stored contents of the reference table TBL2. In the reference TBL2, the rank, the promotion condition, and the maintenance condition are associated with each other and stored. For example, the promotion condition for promoting to the rank A is that cumulative points for the most recent six months is greater than 10,000 points. The promotion condition for promoting to the rank B is that cumulative points for the most recent six months is greater than 5,000 points. The higher the rank is, the harsher the promotion condition is. For example, the maintenance condition for maintaining the rank A is that obtained points per month is greater than 2,000 points. The maintenance condition for maintaining the rank B is that obtained points per month is greater than 1,000 points.

For example, assuming that the obtained points of a member are provided with 2,000 points in January, 1,500 points in February, 3,000 points in March, 2,000 points in April, 2,000 points in May, 2,500 points in June, 2,500 points in July, and 1,200 points in August, in this case, since cumulative points from January to March are 5,500 points, the rank of the member in April is “B”. Since the obtained points in each month from April to June are greater than 1,000, the rank B is maintained from April to June. Since cumulative points from January to June are 12,000 points, the rank of the member is promoted to “A”. Although the obtained points in July are 2,500 points, which is greater than 2,000 points, the obtained points in August are 1,200 points, which are less than 2,000 points. Therefore, although the rank in July and August is “A”, the rank is demoted to “B”.

### 2. Operation of the Member System

The operation of the member system will be described below.

### 2-1: Registration of Point Information

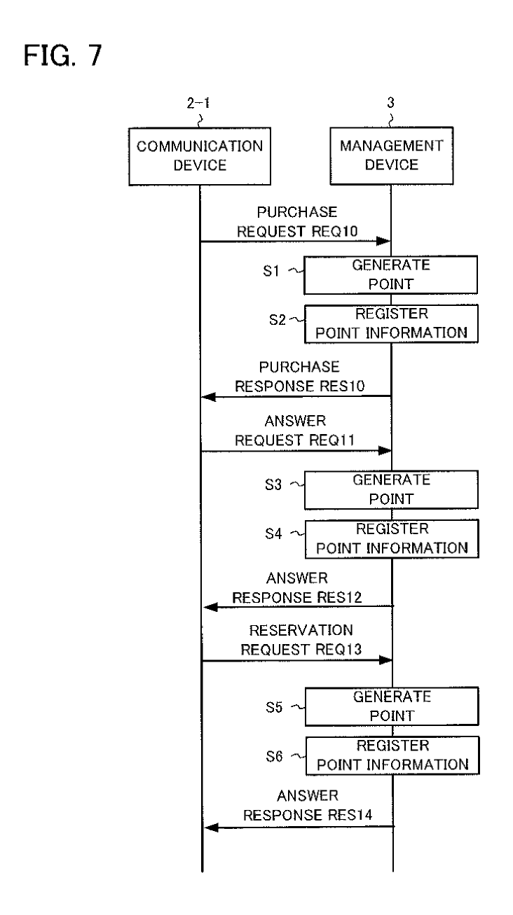

FIG. 7 is a sequence diagram showing the operation of the member system relating to the registration of the point information. In this example, assuming that as a result of which a member X of the communication device 2-2 carries out activity on the website, points are given and registered in the member database DB as the point information.

For example, a purchase request REQ10 for goods or services is sent from the communication device 2-1 to the management apparatus 3. In the purchase request REQ 10, the member ID of the member X, who is a requesting source, information for specifying goods or services to be purchased, and the amount of payment for the goods or services are included. When the CPU 40 of the management apparatus 3 receives the purchase request REQ10, the CPU performs a process necessary to purchase the goods or services, and generates points corresponding to one-tenth of the amount of the payment (S1). The CPU 40 registers the points and time when the points are obtained in a point information field corresponding to the member ID of the member X in the member database DB (S2). The CPU 40 sends a purchase response RES 10 including the amount of the payment, points, and the like to the communication device 2-1. As described below, the CPU 40 of the management apparatus 3, which receives the purchase request REQ10, calculates a discount rate to the amount of the payment in accordance with the rank of the member X and the like. The explanation of this process will be omitted here.

Similarly, an answer request REQ 11 for answering a question posted on the website is sent from the communication device 2-1 to the management apparatus 3. In this answer request REQ11, the member ID of the member X, who is a requesting source, information for specifying the post to be answered, and information indicating the contents of the answer are included. When the CPU 40 of the management apparatus 3 receives the answer request REQ11, the CPU 40 performs a processing for displaying the contents of the answer on the website. Then, the CPU 40 generates 50 points, for example (S3). The CPU 40 registers the points and time when the points are obtained in the point information field corresponding to the member ID of the member X in the member database DB (S4). The CPU 40 sends an answer response RES12 including the effect that the answer is displayed, points, and the like, to the communication device 2-1.

A reservation request REQ 13 indicating the effect that the member X hosts the reservation of a golf course, which multiple members make jointly, is sent from the communication device 2-1 to the management apparatus 3. In the reservation request REQ 13, the member ID of the member X, who is a requesting source, the member IDs of the multiple members, who make the reservation of the golf course together, and the contents of the reservation are included. When the CPU 40 of the management apparatus 3 receives the reservation request REQ13, the CPU 40 performs a process necessary to make the reservation. Then, the CPU 40 generates 100 points, for example (S5). The CPU 40 registers the points and time when the points are obtained in the point information field corresponding to the member ID of the member X in the member database DB (S6). The CPU 40 sends a reservation response RES14 including the effect that the reservation is completed, the points, and the like, to the communication device 2-1.

As described above, since points are given for not only the amount of the payment for the purchase, but also the activity to the other members, it is possible to expedite the communication between members and to stimulate the activity of the members.

### 2-2: Registration of Relationship of Friends

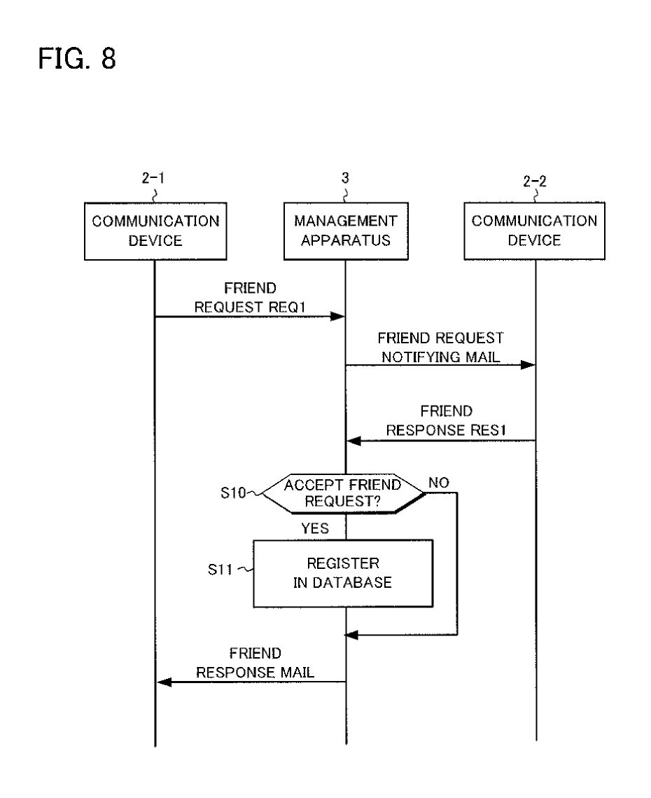

FIG. 8 is a sequence diagram showing the operation of the member system relating to the registration of the relationship of friends. In the example, it is assumed that the member X of the communication device 2-1 offers a request that the member X be a friend to member Y of the communication device 2-2.

A friend request REQ 1 is sent from the communication device 2-1 to the management apparatus 3. In the friend request REQ 1, a member ID of the member X, who is a requesting source, and a member ID of the member Y, who is a requesting destination, is included. When the management device 3 receives the friend request REQ 1, the CPU 40 registers an icon to be displayed on a public page of the member Y, the icon indicating that the friend request from the member X has been received. The CPU 40 obtains a mail address of the member Y by referring to the member database DB, so that the CPU 40 sends a friend request notifying mail to the mail address. The member Y can know that there has been a friend request by the mail. Since the member Y can know that there has been a friend request by accessing the public page of the member Y on the website, the friend request mail may be omitted.

When the member Y accesses the public page of the member Y, the member Y can know that there has been a friend request from the member X. The member Y can know that personality of the member X by accessing the public page of the member X. The member Y decides whether or not the member Y would like to make friends with the member X, so that a friend response RES 1 is sent to the management apparatus 3. In the friend response RES 1, the member ID of the member Y, who is a sending source, authentication information indicating whether or not the registration as a friend is authenticated, and the member ID of the member X, who is a requesting source.

When the management apparatus 3 receives a friend response RES 1 from the communication device 2-2, the CPU 40 determines whether or not the requesting source is authenticated as a friend on the basis of the authentication information (S10). If the authentication information indicates that the requesting source is authenticated as a friend, the CPU 40 accesses the member database DB to associate the member ID of the member X, who is a requesting source, with the member ID of the member Y, who is a requesting destination, and record them as friend information (S11). The CPU 40 draws up a friend response mail to send it to the communication device 2-1. If the authentication information indicates that the requesting source is not authenticated as a friend, the CPU 40 draws up the friend response mail without accessing the member database DB to send it to the communication device 2-1.

The friend response mail includes information indicating whether or not the member Y authenticates the requesting source as a friend. The CPU 40 reads out a mail address corresponding to the member ID of the member X, which is included in the friend response RES 1, from the member database DB, so that the CPU draws up the text of a mail on the basis of the authentication information included in the friend response RES 1 to send the friend response mail to the member X. Thus, the member X can know that the member X has been able to make a friendship relationship with the member Y.

### 2-3: The Purchase of Goods or Services

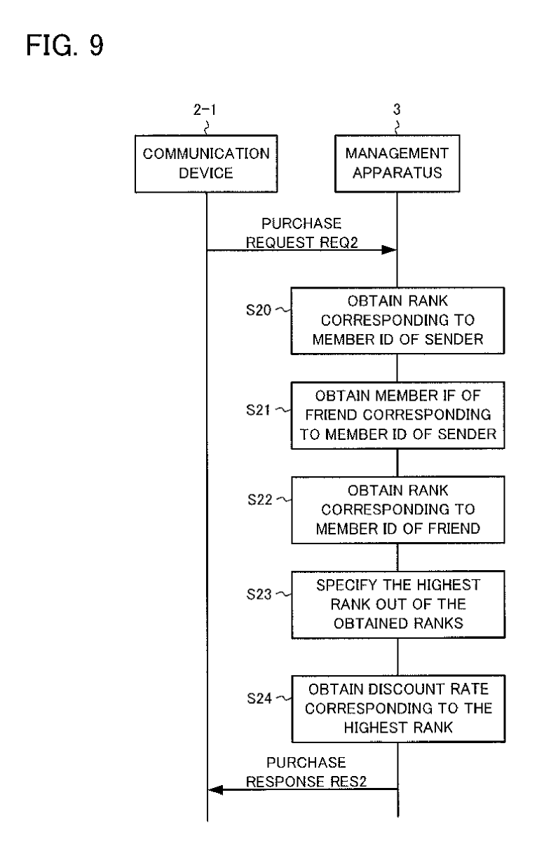

FIG. 9 shows the operation for the member system relating to the purchase of goods or services. In this example, assuming that the member ID of the member X of the communication device 2-1 is “0004”, and the stored contents of the member database DB are the ones shown in FIG. 4.

A purchase REQ 2 is sent from the communication device 2-1 of the member X to the management apparatus 3. The purchase request REQ 2 includes the member ID of the member X and designation information designating goods or services as a subject of the purchase.

When the management device 3 receives the purchase request REQ 2, the CPU 30 accesses the member database DB to obtain a rank corresponding to the member ID of the member X (S20). As shown in FIG. 4, since the rank corresponding to the member ID “0004” of the member X is “E”, the CPU 40 obtains a rank E.

The CPU 40 accesses the member database DB, so that the CPU 40 reads out friend information corresponding to the member ID of the member X to obtain the member ID of friends (S21). As shown in FIG. 4, since the member IDs of friends corresponding to the member ID “0004” of the member X are “0001”, “0002” and “0003”, the CPU 40 obtains those.

The CPU 40 accesses the member database DB to obtain a rank corresponding to the member ID of each friend (S22). In the example shown in FIG. 4, since the rank corresponding to the member ID “0001” of a friend is “A”, the rank corresponding to the member ID “0002” of a friend is “D”, and the rank corresponding to the member ID “0003” of a friend is “B”, the CPU 40 obtains the rank “A”, “D” and “B”.

After that, the CPUT 40 specifies the highest rank out of the obtained ranks of the member X and the friends (S23). In this example, the CPU 40 specifies the rank A. The CPU 40 refers to the privilege table TBL 1 to obtain a discount rate corresponding to the highest rank (S24). As shown in FIG. 5, since the discount rate corresponding to the rank A is 10%, the CPU 40 obtains 10% as the discount rate.

The CPU 40 calculates the amount of the payment by applying the discount rate to the sum of goods or services as a subject of the purchase designated in the designation information, so that the CPU 40 sends a purchase response RES 2 including the amount of the payment to the communication device 2-1.

Even if a member is one having a low rank, the member can accept the same discount rate as that the friends can accept when the member makes friends with a member having a higher rank. Thus, it is expected that a lot of friend requests will be offered to a member having a higher rank. Since a member as a requesting destination having a higher rank decides whether or not the member accepts a friend request by referring to how a member as a requesting source carries out activity, there is an advantage that the activity of the members on the website is vitalized.

### 2-4: Updating of Rank

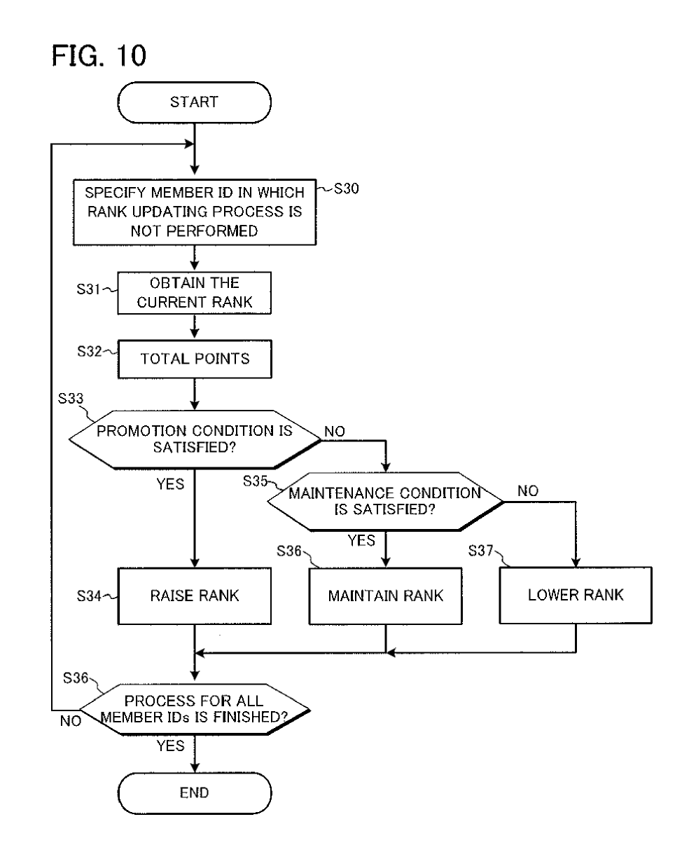

An updating process of a rank will be described. FIG. 10 shows a flow chart of the updating process of a rank executed by the CPU 40. The updating process of a rank is executed at a predetermined period, for example, once a month.

The CPU 40 specifies one member ID, for which the updating process is not performed (S30), so that the CPU 40 refers to the member database DB to obtain a current rank corresponding to the member ID (S31).

The CPU 40 refers to the member database DB, so that the CPU 40 reads out point information corresponding to the member ID to accumulate points obtained for a predetermined period (S32). The CPU 40 reads out a promotion condition corresponding to the current rank from the reference table TBL 2, so that the CPU 40 compares the accumulated points with reference points of the promotion condition to determine whether or not the promotion condition is satisfied (S33).

As shown in FIG. 5, the promotion condition to a rank D relates total points in an entire period, the promotion condition to a rank B or C relates total points for the latest three months, and the promotion condition to a rank A relates total points in the latest six months. Thus, if the current rank is “E”, the predetermined period is the entire period, three months, and six months, so that the total points are calculated for each period. If the current rank is “D” or “C”, the predetermined period is three months and six months, so that the total points are calculated for each period. If the current rank is “B”, the predetermined period is six months, so that the total points for the period is calculated. If the rank is “A”, there is no promotion more than the rank, so that the calculation of the total points is not executed.

For example, if the current rank is “D”, the CPU 40 determines whether or not the total points in the entire period is greater than 500 points, which is reference points necessary to promote to a rank E, whether or not the total points in three months is greater than 2000 points, which is reference points necessary to promote to a rank C, whether or not the total points in three months is greater than 5000 points, which is reference points necessary to promote to a rank B, and whether or not the total points in six months is greater than 10000 points, which is reference points necessary to promote to a rank A.

If the promotion condition is satisfied, the CPU 40 promotes a rank of the members to the rank satisfying the promotion condition to update rank information associated with the member ID recorded in the member database DB (S34). If the promotion conditions for multiple ranks are satisfied, the highest rank is adopted.

If the promotion condition is not satisfied, the CPU 40 determines whether or not a maintenance condition of the current rank is satisfied (S35). As shown in FIG. 5, the maintenance condition of the rank C is to obtain 500 points per month, the maintenance condition of the rank B is to obtain 1000 points per month, and the maintenance condition of the rank A is to obtain 2000 points per month. There is no maintenance condition for the ranks D and E.

The CPU 40 calculates the total points for one month if the current rank is “C”, the CPU 40 determines whether or not the total points is greater than 500 points, which is the reference points of the maintenance condition. The CPU 40 calculates the total points for one month if the current rank is “B”, the CPU 40 determines whether or not the total points is greater than 1000 points, which is the reference points of the maintenance condition. The CPU 40 calculates the total points for one month if the current rank is “A”, the CPU 40 determines whether or not the total points is greater than 2000 points, which is the reference points of the maintenance condition.

If the maintenance condition is satisfied, the CPU 40 maintains the current rank, so that the CPU 40 does not update the rank information of the member database DB (S36). If the maintenance condition is not satisfied, the CPU 40 updates the rank information of the member database DB so that the current rank goes to one rank down (S37).

After that, the CPU 40 determines whether or not the above-mentioned process is finished for all the member IDs (S38), the CPU 40 repeats the processes from step S30 to step S36 until the process for all the member IDs is finished, so that the CPU 40 finishes the updating process when the process for all the members IDs is finished.

According to the embodiment, points obtained for a predetermined period are accumulated by referring to the member database DB for each of multiple members. The rank is decided for each of the multiple members by comparing the accumulated points with the reference points of the promotion condition and maintenance condition. The decided rank is recorded in the member database DB. Thus, if the condition is satisfied by points obtained on the website, the rank of the members is promoted or demoted. Since the privilege according to the rank is given, high motivation to the promotion and maintenance of the rank is generated, so that it is possible to vitalize the activity of the members on the website. If the friendship relationship is made between members, the privilege corresponding to the rank of the other members is given, the building of the friend relationship is stimulated, and it is possible to stimulate the activity of the members.

In the embodiment, since points that each member obtains are associated with time used for obtaining individual points and recorded in the database, points obtaining history can be recorded individually. As a result, since it is possible to manage the detailed history of individual activity, it is beneficial for both the members and the manager. In the embodiment, since the promotion condition and maintenance condition are stored in the reference table TBL 2, and the updating of the rank is executed by referring the conditions, it is possible to easily adjust the rank of the members only by changing the reference table TBL 2. If there is deviation in the structure of the rank of the members, profit may be decreased or increased in the operation of the member system 100. In that case, by changing the reference points of the promotion condition, it is possible to adjust the structure of the rank so that appropriate profit can be gained. It is also possible to adjust the structure by changing the maintenance condition for each month. For example, if profit is decreased, the promotion condition to a rank A is changed from 10,000 points to 12,000 points as the accumulated points for the most recent six months. Alternatively, the maintenance condition to a rank A is changed from 2,000 points per month to 2,500 points per month. The amount of the points given in each service may be adjusted. Since the points in the embodiment are not equivalent to cash, and are not allotted for the payment, there is an advantage that it is hard to offend the members with respect to the change of the condition.

### 3. Variation

The present invention is not limited to the above-mentioned embodiment. For example, variations described below are possible. Two or more modes freely selected from the following examples can be appropriately combined.

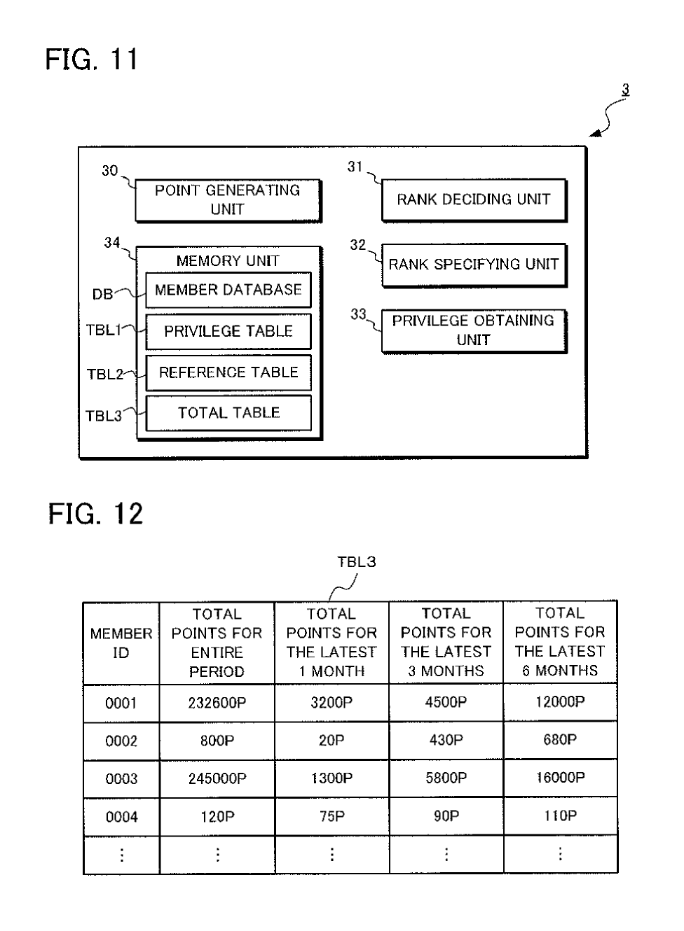

(1) In the above-mentioned embodiment, the points obtained by the members and time when the points are obtained are stored as point information in the member database DB. In the process of updating of the rank, the stored points are accumulated. The present invention is not limited to this example. The total value of the obtained points may be stored in a total table, so that the points stored in the total table may be referred to. As shown in FIG. 11, the management apparatus 3 in the variation includes a total table TBL 3 in the memory unit 34. The memory unit 34 is a function to be realized by a hard disc, etc., as in the above-mentioned embodiment.

FIG. 12 shows an example of the total table TBL 3. In the total table TBL 3, the member ID and the total points are associated with each other and are stored. The total points are divided into points for the entire period, points for the most recent month, points for the most recent three months, and points for the most recent six months. The CPU 40 accesses the total table TBL 3 every time each member obtains the points to update the total points.

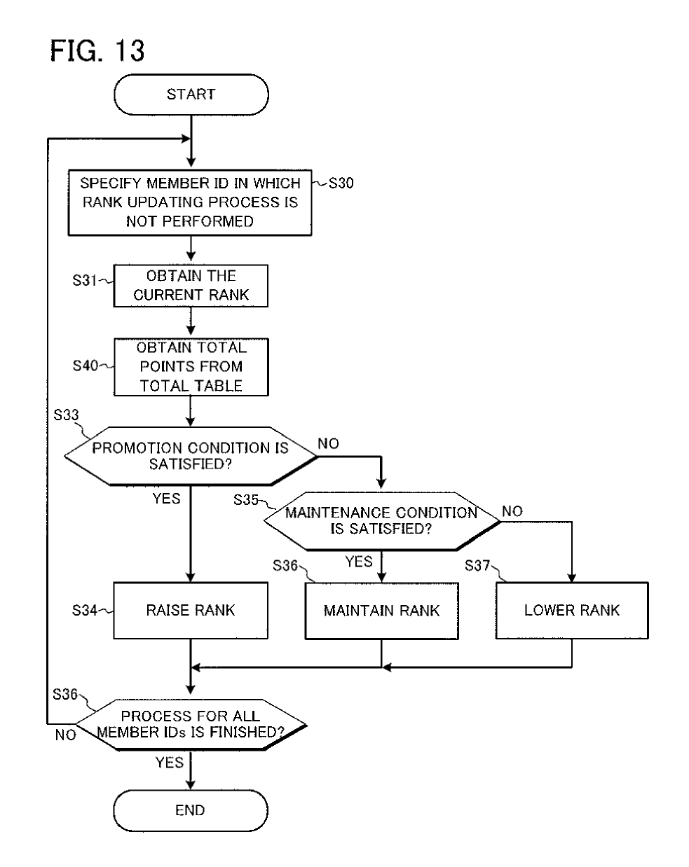

A rank updating process in the variation will be described referring to FIG. 13. The CPU 40 specifies one member ID (S30), in which the updating process of the rank is not performed, so that the CPU 40 obtains the current rank corresponding to the member ID by referring to the member database DB (S31).

The CPU 40 reads out the total points corresponding to the member ID by referring to the total table TBL 13 (S40). The CPU 40 reads out the promotion condition corresponding to the current rank from the reference table TBL 2, so that the CPU 40 determines whether or not the promotion condition is satisfied by comparing the total points obtained from the total table TBL 3 with the reference points of the promotion condition (S33).

If the promotion condition is satisfied, the CPU 40 promotes the member's rank to the rank that satisfies the promotion condition to update the rank information corresponding to the member ID stored in the member database DB (S34). If the promotion conditions to the multiple ranks are satisfied, the highest rank is adopted. If the promotion condition is not satisfied, the CPU 40 determines whether or not the maintenance condition of the current rank is satisfied (S35).

If the maintenance condition is satisfied, the CPU 40 maintains the current rank, so that the CPU 40 does not update the rank information of the member database D (S36). If the maintenance condition is not satisfied, the CPU 40 updates the rank information of the member database D so that the current rank goes to one rank down (S37).

After that, the CPU 40 determines whether or not the above-mentioned process is finished for all the member IDs (S38), the CPU 40 repeats the processes from step S30 to step S36 until the process for all the member IDs is finished, so that the CPU 40 finishes the updating process when the process for all the members IDs is finished.

In this case, since the total points are calculated every time the member obtains the points, it is unnecessary to accumulate the total points intensively at the time of the updating of the rank. Therefore, it is possible to distribute the processing load of the CPU 40 temporally. Since the total value for a predetermined period is stored in the total table, it is possible to reflect the degree of the activity of the members at every predetermined period in the rank. Since the evaluation of the rank is performed with respect to the activity for the predetermined period, it is not the past activity outside of the predetermined period, but the latest activity that will be evaluated by setting the predetermined period appropriately (for example, the latest six months). Therefore, it is possible to stimulate the continuation of the activity of the members. The promotion condition for each rank may be decided in accordance with the total points for the entire period. In this case, it is possible to carry out the promotion of the rank in real time.

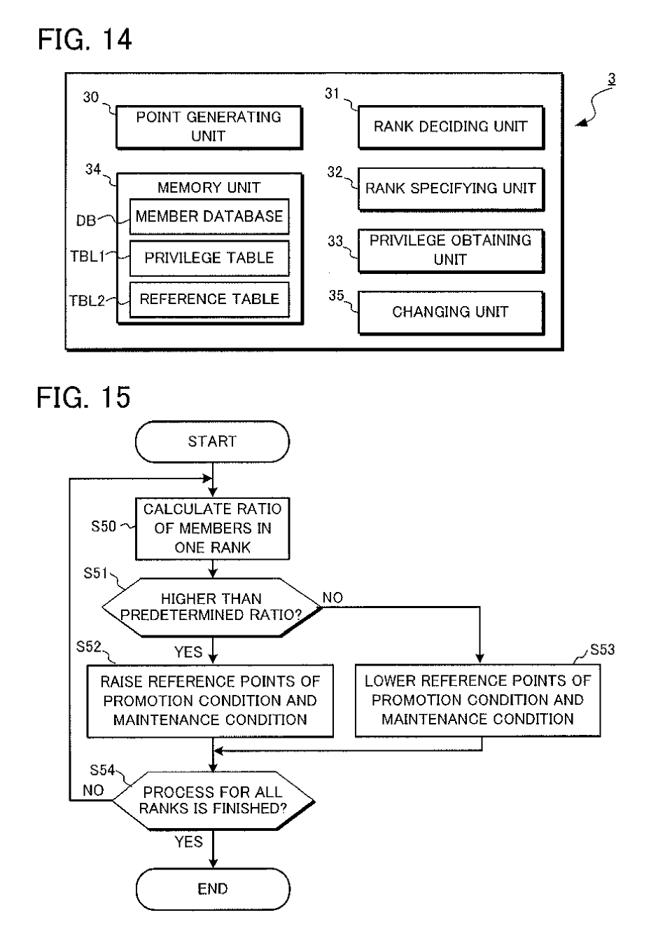

(2) In the above-mentioned embodiment, if the promotion condition and maintenance condition stored in the reference table TBL 2 is changed, the input by the manager of the management apparatus 3 is needed. The present invention is not limited to this example. The stored contents may be automatically changed in the reference table TBL 2. As shown in FIG. 14, the management apparatus 3 of the variation includes a changing unit 35. The CPU 40 shown in FIG. 4 executes a computer program to function in accordance with the computer program, so that the changing unit 35 is realized as a functional block.

In this case, the CPU 40 may automatically change the reference points of the promotion condition and maintenance condition stored in the reference table TBL 2 so that the ratio of the members belonging to each rank comes into a predetermined ratio. For example, as shown in FIG. 15, the CPU 40 calculates the ratio of the members belonging to a rank (S50), so that the CPU 40 determines whether or not the ratio is higher than the predetermined ratio (S51). If the calculated ratio is higher than the predetermined ratio, the CPU 40 raises the promotion condition and maintenance condition by raising the reference points corresponding to the rank (S52). However, if the calculated ratio is lower than the predetermined ratio, the CPU 40 eases the promotion condition and maintenance condition by lowering the reference points corresponding to the rank (S53). The CPU 40 repeats the above-described process until the process is performed for all the ranks (S54).

It is preferable to change the promotion condition preferentially compared to the maintenance condition. Since it has been impossible to maintain the rank by the obtained points per month, by which it had been possible to maintain the rank, if the maintenance condition is raised, the members are expected to be confused. However, since the current rank is maintained if the promotion condition is raised, there will be a little opposition by the members.

Although an example in which the changing unit 35 is provided in the management apparatus 3 in the above-mentioned embodiment is described in this variation, the changing unit 35 may be provided in the management apparatus 3 in the variation shown in FIG. 11.

According to this variation, since the contents of the reference table can be automatically changed, it is possible to control the ratio of the rank of the members.

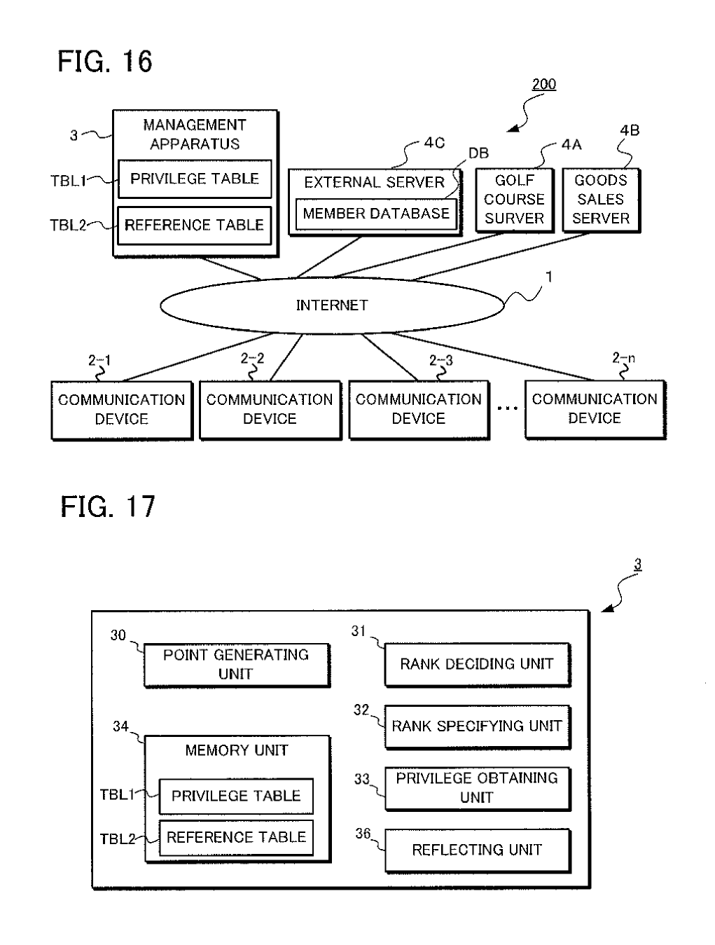

(3) In the above-mentioned embodiment and variations, the example in which the member database DB is provided within the management apparatus 3. However, the present invention is not limited to such a configuration. As shown in the member system 200 shown in FIG. 16, the member database DB may be provided in an external server 4C to obtain data from the member database DB through the Internet 1.

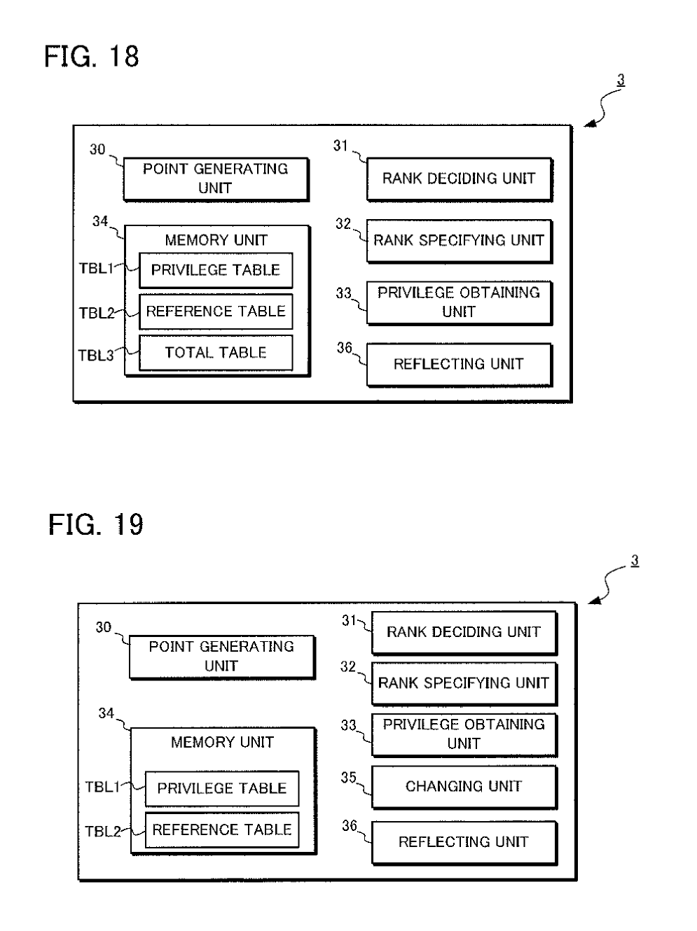

In the above-mentioned embodiment, in the case of accessing the member database DB of the external server 4C through the Internet 1, a reflecting unit 36 may be provided as a function of the management apparatus 3 as shown in FIG. 17. As described above, when the process of updating of the rank is performed, the updated rank may be stored and reflected in the member database DB of the external server 4 by the reflecting unit 36. Similarly, in the case of the variation shown in the FIG. 11, the reflecting unit 36 may be provided as a function of the management apparatus 3 as shown in FIG. 18. In the case of the variation shown in FIG. 14, the reflecting unit 36 may be provided as a function of the management apparatus 3 as shown in FIG. 19.

### LIST OF REFERENCE SIGNS

1 . . . Internet, 2-1 to 2-n . . . communication device, 3 . . . management apparatus, 4A . . . golf course server, 4B . . . goods sales server, DB . . . database, TBL 1 . . . privilege table, TBL 2 . . . reference table, TBL 3 . . . total table, 100, 200 . . . member system

1. A management apparatus for managing a website for multiple members, comprising:
a point generating unit adapted for generating points in accordance with the degree of activity of the members on the website,
a rank deciding unit adapted for evaluating the activity of each of the multiple members to decide a rank,
a database, in which identification information that identifies the members, the points of the members, ranks of the members, and identification information of a member who has a friend relationship with the members are associated with each other and stored,
a privilege table, in which privilege in accordance with the rank is stored,
a rank specifying unit adapted for, when a purchase request indicating the purchase of goods or services provided on the website is received, obtaining the identification information of a friend corresponding to the identification included in the purchase request from the database, obtaining ranks corresponding to the identification information of the member who sent the purchase request and the identification information of the friend from the database, and specifying the highest rank out of the obtained ranks, and
a privilege obtaining unit adapted for referring to the privilege table to obtain privilege corresponding to the rank specified by the rank specifying unit,
wherein the obtained privilege is applied to the purchase of goods or services of the member.

2. The management apparatus according to claim 1, wherein the point generating unit generates the points relating to an amount of payment of the member in the purchase, and generates the points in accordance with the activity, which the member carries out with respect to the other members.

3. The management apparatus according to claim 1, wherein the management apparatus comprises a total table, in which the identification information and the total value of the points generated by the point generating unit are associated with each other and stored,
the rank deciding unit evaluates the activity of each of the multiple members to decide the rank on the basis of the total value of the points stored in the total table.

4. The management apparatus according to claim 3, wherein the rank deciding unit comprises a reference table, in which multiple reference points as references of ranking are stored, and
the rank deciding unit evaluates the activity of each of the multiple members to decide the rank on the basis of the reference table and the total value of the points stored in the total table for a predetermined period.

5. The management apparatus according to claim 1, wherein individual points obtained by the members and time when the points are obtained are associated with each other and stored in the database,
the rank deciding unit comprises a reference table, in which multiple reference points as references of ranking are stored, and
the rank deciding unit accumulates the points obtained for a predetermined period by referring to the database, decides the rank for each of the multiple members by comparing the accumulated points with the reference points, and stores the decided rank in the database.

6. The management apparatus according to claim 4, comprising a changing unit adapted for changing the multiple reference points stored in the reference table so that the ratio of the members belonging to each rank goes to a predetermined ratio.

7. A management apparatus for managing a website for multiple members, and being capable of communicating with a database in which identification information identifying the members, points of the members, ranks of the members, and identification information of members who have a friend relationship with the members are associated with each other and stored, comprising:
a point generating unit adapted for generating points in accordance with the degree of activity of the members on the website,
a rank deciding unit adapted for evaluating the activity of each of the multiple members to decide the rank,
a reflecting unit adapted for reflecting the decided rank in the database,
a privilege table, in which privilege in accordance with the rank is stored,
a rank specifying unit adapted for, when a purchase request indicating the purchase of goods or services provided on the website is received, obtaining the identification information of a friend corresponding to the identification included in the purchase request from the database, obtaining ranks corresponding to the identification information of the member who sent the purchase request and the identification information of the friend from the database, and specifying the highest rank out of the obtained ranks, and
a privilege obtaining unit adapted for referring to the privilege table to obtain privilege corresponding to the rank specified by the specifying unit,
wherein the obtained privilege is applied to the purchase of goods or services of the member.

8. A management method for being performed in a management apparatus for managing a website for multiple members, comprising:
generating points in accordance with the degree of activity of the members on the website,
evaluating the activity of each of the multiple members to decide a rank,
associating identification information that identifies the members, the points of the members, ranks of the members, and identification information of a member who has a friend relationship with the members with each other and storing them,
storing privilege in accordance with the rank,
when a purchase request indicating the purchase of goods or services provided on the website is received, obtaining the identification information of a friend corresponding to the identification included in the purchase request from the database,
obtaining ranks corresponding to the identification information of the member who sent the purchase request and the identification information of the friend from the database,
specifying the highest rank out of the obtained ranks, and
obtaining privilege corresponding to the rank specified,
wherein the obtained privilege is adopted for the purchase of goods or services of the member.

9. A management method for being performed in a management apparatus for managing a website for multiple members, and being capable of communicating with a database in which identification information identifying the members, points of the members, ranks of the members, and identification information of members who have a friend relationship with the members are associated with each other and stored, comprising:
generating points in accordance with the degree of activity of the members on the website,
evaluating the activity of each of the multiple members to decide the rank,
reflecting the decided rank in the database,
storing privilege in accordance with the rank,
when a purchase request indicating the purchase of goods or services provided on the website is received, obtaining the identification information of a friend corresponding to the identification included in the purchase request from the database,
obtaining ranks corresponding to the identification information of the member who sent the purchase request and the identification information of the friend from the database,
specifying the highest rank out of the obtained ranks, and
obtaining privilege corresponding to the rank specified,
wherein the obtained privilege is applied to the purchase of goods or services of the member.

10. The management apparatus according to claim 2, wherein the management apparatus comprises a total table, in which the identification information and the total value of the points generated by the point generating unit are associated with each other and stored,
the rank deciding unit evaluates the activity of each of the multiple members to decide the rank on the basis of the total value of the points stored in the total table.

11. The management apparatus according to claim 10, wherein the rank deciding unit comprises a reference table, in which multiple reference points as references of ranking are stored, and
the rank deciding unit evaluates the activity of each of the multiple members to decide the rank on the basis of the reference table and the total value of the points stored in the total table for a predetermined period.

12. The management apparatus according to claim 2, wherein individual points obtained by the members and time when the points are obtained are associated with each other and stored in the database, the rank deciding unit comprises a reference table, in which multiple reference points as references of ranking are stored, and
the rank deciding unit accumulates the points obtained for a predetermined period by referring to the database, decides the rank for each of the multiple members by comparing the accumulated points with the reference points, and stores the decided rank in the database.

13. The management apparatus according to claim 11, comprising a changing unit adapted for changing the multiple reference points stored in the reference table so that the ratio of the members belonging to each rank goes to a predetermined ratio.

14. The management apparatus according to claim 12, comprising a changing unit adapted for changing the multiple reference points stored in the reference table so that the ratio of the members belonging to each rank goes to a predetermined ratio.

15. The management apparatus according to claim 5, comprising a changing unit adapted for changing the multiple reference points stored in the reference table so that the ratio of the members belonging to each rank goes to a predetermined ratio.
